(19) United States
(12) Patent Application Publication
(10) Pub. No.: US 2023/0070697 A1
(43) Pub. Date: Mar. 9, 2023

(54) PROCESS FOR PRODUCING AN ETHER ESTEROL

(71) Applicant: Covestro Deutschland AG, Leverkusen (DE)

(72) Inventors: Aurel Wolf, Wülfrath (DE); Martin Machat, Köln (DE); Christoph Guertler, Köln (DE)

(21) Appl. No.: 17/795,082

(22) PCT Filed: Feb. 26, 2021
(86) PCT No.: PCT/EP2021/054879

§ 371 Date: Jul. 25, 2022

(30) Foreign Application Priority Data
Mar. 3, 2020 (EP) 20160554.0

(51) Int. Cl. C08G 63/66; C08G 18/42; C08G 18/72

(52) U.S. Cl. CPC C08G 63/66; C08G 18/4252; C08G 18/72; C08G 2110/0025

(57) ABSTRACT

A process for producing an ether esterol, preferably a polyether esterol, by reacting an H-functional starter substance with a cyclic anhydride and an alkylene oxide in the presence of a catalyst is provided. An ether sterol and a process for preparing a polyurethane are also provided.

### CROSS REFERENCE TO RELATED APPLICATIONS

This application is a U.S. national stage application, filed under 35 U.S.C. § 371, of International Application No. PCT/EP2021/054879, which was filed on Feb. 26, 2021, which claims priority to European Patent Application No. 20160554.0, which was filed on Mar. 3, 2020. The contents of each are hereby incorporated by reference into this specification.

### FIELD

The invention provides a process for preparing an etheresterol, preferably a polyetheresterol, by reaction of an H-functional starter substance (1) with a cyclic anhydride (2) and an alkylene oxide (3) in the presence of a catalyst (4). The invention further provides etheresterols, preferably polyetheresterols, obtainable by the process of the invention.

### BACKGROUND

DE 2142161 discloses a process for preparing flexible polyurethane foams based on ester-containing polyether polyols, wherein the ester-containing polyether polyols are prepared by a sequential reaction based on the reaction of cyclic anhydrides with polyols, followed by an ethoxylation, in order to reduce the acid number.

U.S. Pat. No. 4,582,926 discloses a process for preparing polyesters or polyester polyols by reacting polyols with cyclic carboxylic anhydrides in the presence of catalysts to give monoesters, wherein these monoesters are subsequently reacted with ethylene oxide to give reaction products. In this case, the usually amine-based catalysts are added prior to addition of the alkylene oxide.

DE3621039 A1 discloses a process for preparing low-viscosity oligoesters having hydroxyl groups, wherein these are obtained by reaction of polyhydric alcohols or dialkanolamines with cyclic carboxylic anhydrides in the presence of amine-based catalysts and subsequent alkoxylation of the monoesters with ethylene oxide and/or propylene oxide. The amine catalysts are likewise added here in the synthesis of the monoester or before reaction with the alkylene oxides.

WO 2011/137011 A1 discloses a process for preparing polyester polyether polyols by reacting a component containing carboxyl groups, a polyol with an alkylene oxide in the presence of a double metal cyanide catalyst, a superacid or the salt of a superacid as catalyst or a tertiary amine catalyst, wherein the amine catalysts are likewise added in the synthesis of the monoester or before reaction with the alkylene oxides.

WO 2011/000560 A1 discloses a three-stage process for preparing polyetherester polyols having primary hydroxyl end groups, comprising the steps of reacting a starter compound having active hydrogen atoms with an epoxide under double metal cyanide catalysis, reacting the product obtained with a cyclic carboxylic anhydride and reacting this product obtained with ethylene oxide in the presence of a catalyst comprising at least one nitrogen atom per molecule, excluding noncyclic tertiary amines having identical substitution.

### SUMMARY

It was an object of the present application to provide an efficient and easily scaled-up process for preparing etheresterols, preferably polyetheresterols, having improved process control, in which the product can be provided in a minimum number of preparation steps. In addition, the viscosity of the resulting etheresterol, preferably polyetheresterol, products is to be reduced compared to prior art systems for a defined composition and a given OH number (hydroxyl number), or crystallization of the etheresterols is even to be avoided. The intention is thus to enable use of these products as monool or polyol component directly or at least in a simplified manner in the downstream polyurethane (PU) production, preferably rigid PU foam production. Furthermore, the conversion of the reactants used is also to be improved, for example increasing the conversion of alkylene oxide in order to reduce the complex removal, purification and reuse or disposal of these starting materials, some of which are toxic.

It has been found that, surprisingly, the object of the invention is achieved by a process for preparing an etheresterol, preferably a polyetheresterol, by reacting an H-functional starter substance (1) with a cyclic anhydride (2) and an alkylene oxide (3) in the presence of a catalyst (4), wherein the alkylene oxide (3) in the total amount (m3) is added in at least two portions (m3-1) and (m3-2);

wherein the catalyst (4) in the total amount (m4) is added in at least one portion (m4-2);
wherein the portion (m4-2) of the catalyst (4) is added after the first portion (m3-1) of the alkylene oxide (4);
and wherein the addition of the total amount (m4) of the catalyst (4) is concluded before the addition of the total amount (m3) of the alkylene oxide (3);
and wherein the catalyst (4) is a tertiary amine.

### DETAILED DESCRIPTION

Etheresterols of the invention are understood to mean compounds having one or more ether functionalities (ether groups), one or more ester functionalities (ester groups), and one or more hydroxyl functionalities (monools or polyols). The ether functionalities result here from ring opening of the alkylene oxide (3) and addition at least of two or more alkylene oxides onto an H-functional starter substance (1). The ester functionalities are formed, for example, by ring opening of the cyclic anhydride (2) and reaction with a compound containing hydroxyl groups, such as H-functional starter substance (1) having terminal hydroxyl groups. The hydroxyl functionalities (monools or polyols) result from the ring opening of the alkylene oxide (3) and addition onto H-functional starter substance (1) and/or onto monoesters formed by ring opening of the cyclic anhydrides (2). According to the invention, the number of respective ether, ester and hydroxyl functionalities, primarily of ether and ester functionalities, depends on the molar ratio of the H-functional starter substance (1), of the cyclic anhydride (2) and of the alkylene oxide (3) used. In addition, the hydroxyl functionality (mono- or polyol) is highly dependent on the functionality of the H-functional starter substance (1) used. In addition, it is also possible to form additional imide functionalities or amide functionalities when an NH-functional starter substance (1-3) or an NH2-functional starter substance (1-2) is used.

According to the invention, a polyetheresterol has one or more ether functionalities, preferably multiple ether functionalities, one or more ester functionalities, preferably multiple ester functionalities, and one or more hydroxyl functionalities, preferably multiple hydroxyl functionalities, that may be distributed randomly and/or in blocks over the polyetheresterol.

In one embodiment of the process of the invention, the H-functional starter substance (1) is an OH-functional starter substance (1-1), an NH2-functional starter substance (1-2), an NH-functional starter substance (1-3) and/or a COOH-functional starter substance (1-4), preferably an OH-functional starter substance (1-1).

An OH-functional starter substance (1-1) is understood here to mean a compound having at least one free hydroxyl group, an NH2-functional starter substance (1-2) to mean one having at least one primary amine group, an NH-functional starter substance (1-3) to mean one having at least one secondary amine group, and/or a COOH-functional starter substance (1-4) to mean one having at least one free carboxyl group.

H-functional starter substances selected may, for example, be one or more compounds selected from the group comprising water or monohydric or polyhydric alcohols, monobasic or polybasic carboxylic acids, hydroxycarboxylic acids, hydroxy esters, polyether polyols, polyester polyols, polyesterether polyols, polyethercarbonate polyols, poly etherestercarbonate polyols, polycarbonate polyols, polycarbonates, polytetrahydrofurans (e.g. PolyTHF® from BASF, such as PolyTHF® 250, 650S, 1000, 1000S, 1400, 1800, 2000), polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule. Examples of C1-C23 alkyl fatty acid esters containing an average of at least 2 OH groups per molecule are commercial products such as Lupranol Balance® (from BASF AG), Merginol® products (from Hobum Oleochemicals GmbH), Sovermol® products (from Cognis Deutschland GmbH & Co. KG), and Soyol®TM products (from USSC Co.).

Monofunctional starter substances used may be alcohols, thiols and carboxylic acids. Monofunctional alcohols that may be used include: methanol, ethanol, ethenol, 1-propanol, 2-propanol, 2-propenol, 1-butanol, 2-butanol, tert-butanol, 3-buten-1-ol, 3-butyn-1-ol, 2-methyl buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, 1-dodecanol, Palmerol, 1-hexadecanol, phenol, 2-hydroxybiphenyl, 3-hydroxybiphenyl, 4-hydroxybiphenyl, 2-hydroxypyridine, 3-hydroxypyridine, 4-hydroxypyridine.

Suitable polyhydric alcohols as OH-functional starter substances (1-1) having at least two terminal hydroxyl groups are, for example, dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol, octane-1,8-diol, decane-1,10-diol, dodecane-1,12-diol, bis(2-hydroxyethyl) terephthalate, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and also all products of modification of these aforementioned alcohols having different amounts of ε-caprolactone.

Examples of NH2-functional starter substances (1-2) include butylamine, tert-butylamine, pentylamine, hexylamine, aniline, aziridine, pyrrolidine, piperidine, morpholine, pentamethylenediamine (PDA), hexamethylenediamine (HDA), isomorphonediamine (IPDA), toluenediamine (TDA) including the known regioisomers 2,4-TDA, 2,6-TDA, 2,3-TDA and 3,4-TDA, and diaminodiphenylmethane (MDA) including the known regioisomers 2,4′-MDA and 4,4′-MDA.

NH-functional starter substances (1-3) include derivatives of ammonia having alkyl and/or aryl substituents, for example dimethylamine, diethylamine, diisopropylamine, dibutylamine, di-tert-butylamine, dipentylamine, dihexylamine, diphenylamine. In addition, compounds having multiple NH functionalities are possible.

Suitable monobasic carboxylic acids as COOH-functional starter substance (1-4) having a free carboxyl group are methanoic acid, ethanoic acid, propanoic acid, butanoic acid, pentanoic acid, hexanoic acid, heptanoic acid, octanoic acid, lactic acid, stearic acid, palmitic acid, oleic acid, linoleic acid, linolenic acid, benzoic acid, acrylic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid and benzoic acid. In addition, it is possible to use mixtures of fatty acid/fatty alcohol, preferably C10-C18.

Suitable polybasic carboxylic acids as COOH-functional starter substance (1-4) having at least two carboxyl groups include oxalic acid, malonic acid, succinic acid, glutaric acid, adipic acid, pimelic acid, suberic acid, azelaic acid, sebacic acid, trimesic acid, fumaric acid, maleic acid, decane-1,10-dicarboxylic acid, dodecane-1,12-dicarboxylic acid, phthalic acid, isophthalic acid, terephthalic acid, pyromellitic acid and trimellitic acid.

Hydroxycarboxylic acids suitable as H-functional starter substances monobasic carboxylic acids, as COOH-functional starter substance (1-4) having at least one free carboxyl group, are, for example, ricinoleic acid, glycolic acid, lactic acid, 3-hydroxypropionic acid, malic acid, citric acid, mandelic acid, tartronic acid, tartaric acid, mevalonic acid, 4-hydroxybutyric acid, salicylic acid, 4-hydroxybenzoic acid and isocitric acid.

The H-functional starter substances (1) may also be selected from the substance class of the polyether polyols, especially those having a molecular weight Mn in the range from 50 to 4000 g/mol. Preference is given to polyether polyols formed from repeat ethylene oxide and propylene oxide units, preferably comprising a proportion of 35% to 100% propylene oxide units, more preferably comprising a proportion of 50% to 100% propylene oxide units. These may be random copolymers, gradient copolymers, alternating copolymers or block copolymers of ethylene oxide and propylene oxide. Suitable polyether polyols formed from repeat propylene oxide and/or ethylene oxide units are, for example, the Desmophen®, Acclaim®, Arcol®, Baycoll®, Bayfill®, Bayflex®, Baygal®, PET® and polyether polyols from Covestro AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are for example the Pluriol® E products from BASF SE, suitable homopolypropylene oxides are for example the Pluriol® P products from BASF SE, suitable mixed copolymers of ethylene oxide and propylene oxide are for example the Pluronic® PE or Pluriol® RPE products from BASF SE.

The H-functional starter substances (1) may also be selected from the substance class of the polyester polyols, especially those having a molecular weight Mn in the range from 50 to 4500 g/mol. Polyester polyols used may be at least difunctional polyesters. Polyester polyols preferably consist of alternating acid and alcohol units. Examples of usable acid components include succinic acid, succinic anhydride, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride, or mixtures of the stated acids and/or anhydrides. Examples of alcohol components used include ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol, or mixtures of the stated alcohols. The resulting polyester polyols have terminal hydroxyl and/or carboxyl groups.

In addition, H-functional starter substances (1) used may be polycarbonate diols, especially those having a molecular weight Mn in the range from 50 to 4500 g/mol which are prepared, for example, by reaction of phosgene, dimethyl carbonate, diethyl carbonate or diphenyl carbonate and difunctional alcohols or polyester polyols or polyether polyols. Examples for polycarbonates are found, for example, in EP-A 1359177. Polycarbonate diols that may be used include for example the Desmophen® C line from Covestro AG, for example Desmophen® C 1100 or Desmophen® C 2200.

In a further embodiment of the invention, it is possible to use polyethercarbonate polyols (for example Cardyon® polyols from Covestro), polycarbonate polyols (for example Converge® polyols from Novomer/Saudi Aramco, NEOSPOL polyols from Repsol etc.) and/or polyetherestercarbonate polyols as H-functional starter compounds. In particular, polyethercarbonate polyols, polycarbonate polyols and/or polyetherester carbonate polyols can be obtained by reaction of alkylene oxides, preferably ethylene oxide, propylene oxide or mixtures thereof, optionally further comonomers, with CO2 in the presence of a further H-functional starter compound and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt salen catalysts (described for example in U.S. Pat. No. 7,304,172 B2, US 2012/0165549 A1) and/or manganese salen complexes. An overview of the known catalysts for the copolymerization of alkylene oxides and CO2 is provided, for example, by Chemical Communications 47 (2011) 141-163. The use of different catalyst systems, reaction conditions and/or reaction sequences results here in the formation of random, alternating, block-type or gradient-type polyethercarbonate polyols, polycarbonate polyols and/or polyetherestercarbonate polyols. To this end, these polyethercarbonate polyols, polycarbonate polyols and/or polyetherestercarbonate polyols used as H-functional starter compounds may be prepared in a separate reaction step beforehand.

The H-functional starter substances (1) generally have an OH functionality (i.e. the number of polymerization-active H atoms per molecule) of 1 to 8, preferably of 2 to 6 and more preferably of 2 to 4. The H-functional starter substances are used either individually or as a mixture of at least two H-functional starter substances.

Preferred H-functional starter substances are alcohols with a composition according to the general formula (1),

HO—(CH2)ₓ-OH (1)

where x is a number from 1 to 20, preferably an even number from 2 to 20. Examples of alcohols of formula (1) are ethylene glycol, butane-1,4-diol, hexane-1,6-diol, octane-1,8-diol, decane-1,10-diol and dodecane-1,12-diol. Further preferred H-functional starter substances are neopentyl glycol, trimethylolpropane, glycerol and pentaerythritol.

Preference is further given to using, as H-functional starter substances, water, diethylene glycol, dipropylene glycol, castor oil, sorbitol and polyether polyols formed from repeat polyalkylene oxide units.

The OH-functional starter substance (1-1) is more preferably one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, diethylene glycol, dipropylene glycol, glycerol, trimethylolpropane, di- and trifunctional polyether polyols, where the polyether polyol has been formed from a di- or tri-H-functional starter substance and propylene oxide or a di- or tri-H-functional starter substance, propylene oxide and ethylene oxide. The polyether polyols preferably have an OH functionality of 2 to 4 and a molecular weight Mn in the range from 62 to 4500 g/mol and in particular a molecular weight Mn in the range from 62 to 3000 g/mol.

In one embodiment of the process according to the invention, OH functionality is from 2 to 6 and a molecular weight is from 18 g/mol to 2000 g/mol, preferably from 2 to 4 and preferably from 60 g/mol to 1000 g/mol.

In one embodiment of the process of the invention, the H-functional starter substance is one or more compound(s) and is selected from the group consisting of water, ethylene glycol, diethylene glycol, polyethylene glycol, dipropylene glycol, polypropylene glycol, butane-1,3-diol, butane-1,4-diol, 1,1,1-trimethylolpropane, glycerol, pentaerythritol, sorbitol, sucrose, xylitol, propane-1,2-diol, propane-1,3-diol, succinic acid, adipic acid, glutaric acid, pimelic acid, maleic acid, phthalic acid, terephthalic acid, lactic acid, citric acid, salicylic acid and esters of the aforementioned alcohols and acids.

Cyclic anhydrides are cyclic compounds containing an anhydride group in the ring. Preferred compounds are succinic anhydride, maleic anhydride, phthalic anhydride, cyclohexane-1,2-dicarboxylic anhydride, diphenic anhydride, tetrahydrophthalic anhydride, methyltetrahydrophthalic anhydride, norbornenedioic anhydride and chlorination products thereof, glutaric anhydride, diglycolic anhydride, 1,8-naphthalic anhydride, succinic anhydride, dodecenylsuccinic anhydride, tetradecenylsuccinic anhydride, hexadecenylsuccinic anhydride, octadecenylsuccinic anhydride, 3- and 4-nitrophthalic anhydride, tetrachlorophthalic anhydride, tetrabromophthalic anhydride, itaconic anhydride, dimethylmaleic anhydride, allylnorbornenedioic anhydride, 3-methylfuran-2,5-dione, 3-methyldihydrofuran-2,5-dione, dihydro-2H-pyran-2,6(3H)-dione, 1,4-dioxane-2,6-dione, 2H-pyran-2,4,6(3H,5H)-trione, 3-ethyldihydrofuran-2,5-dione, 3-methoxydihydrofuran-2,5-dione, 3-(prop-2-en-1-yl)dihydrofuran-2,5-dione, N-(2,5-dioxotetrahydrofuran-3-yl)formamide and 3 [(2E)-but-2-en-1-yl]dihydrofuran-2,5-dione. Particular preference is given to succinic anhydride, maleic anhydride and phthalic anhydride.

Alkylene oxides (3) used in the process of the invention may be alkylene oxides having 2-45 carbon atoms. The alkylene oxides having 2-45 carbon atoms are, for example, one or more compounds selected from the group comprising ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, alkylene oxides of C6-C22 α-olefins, such as 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example glycidyl ethers of C1-C22 alkanols and glycidyl esters of C1-C22 alkanecarboxylic acids. Examples of derivatives of glycidol are phenyl glycidyl ether, cresyl glycidyl ether, methyl glycidyl ether, ethyl glycidyl ether and 2-ethylhexyl glycidyl ether. Alkylene oxides used are preferably ethylene oxide and/or propylene oxide, more preferably ethylene oxide as alkylene oxide (3).

If ethylene oxide and propylene oxide are used in a mixture, the molar ratio of ethylene oxide to propylene oxide is from 1:99 to 99:1, preferably from 95:5 to 50:50.

In one embodiment of the process of the invention, the cyclic alkylene oxide (3) is added to the reactor continuously or stepwise.

In the process of the invention, a tertiary amine is used as catalyst (4).

Tertiary amines, in accordance with common art knowledge, are derivatives of ammonia having tertiary amine groups in which all 3 hydrogen atoms have been replaced by alkyl, cycloalkyl, aryl groups, where these alkyl, cycloalkyl, aryl groups may be identical or different, also combine to form mono- or polynuclear heterocyclic ring systems. In addition, the tertiary amines may also contain two or more tertiary amine groups. The tertiary amines of the invention may also contain further heteroatoms, for example oxygen.

In one embodiment of the process of the invention, the tertiary amine is one or more compound(s) and is selected from the group consisting of trimethylamine, triethylenediamine, tripropylamine, tributylamine, tripentylamine, trihexylamine, triphenylamine, dimethylethylamine, N,N-dimethylcyclohexylamine, tetramethylenediamine, 1-methyl-4-dimethylaminoethylpiperazine, triethylamine, tripropylamine, tributylamine, dimethylbutylamine, N,N-dimethylbenzylamine, N,N-dimethylcyclohexylamine, N,N′,N″-tris(dimethylaminopropyl)hexahydrotriazine, dimethylaminopropylformamide, N,N,N′,N′-tetramethylethylenediamine, N,N,N′,N′-tetramethylbutanediamine, tetramethylhexanediamine, pentamethyldiethylenetriamine, tetramethyldiaminoethyl ether, dimethylpiperazine, 1,2-dimethylimidazole, 1-azabicyclo[3.3.0]octane, bis(dimethylaminopropyl)urea, bis(dimethylaminoethyl) ether, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, 1,8-diazabicyclo[5.4.0]undec-7-ene (DBU), 1,5,7-triazabicyclo[4.4.0]dec-5-ene (TBD), 1,4-diazabicyclo[2.2.2]octane (DABCO), imidazole, 1-methylimidazole, 2-methylimidazole, 4(5)-methylimidazole, 2,4(5)-dimethylimidazole, 1-ethylimidazole, 2-ethylimidazole, 1-phenylimidazole, 2-phenylimidazole, 4(5)-phenylimidazole and N,N-dimethylaminopyridine, guanidine, 1,1,3,3-tetramethylguanidine, pyridine, 1-azanaphthalene (quinoline), N-methylpiperidine, N-methylmorpholine, N,N′-dimethylpiperazine and N,N-dimethylaniline.

In a preferred embodiment of the process of the invention, the amine catalyst is one or more compound(s) and is selected from the group consisting of benzyldimethylamine, N,N-dimethylcyclohexylamine, diazabicyclo[2.2.2]octane (DABCO), imidazole, 1-methylimidazole, 2-methylimidazole, 4(5)-methylimidazole, 2,4(5)-dimethylimidazole, 1-ethylimidazole, 2-ethylimidazole, 1-phenylimidazole, 2-phenylimidazole, and 4(5)-phenylimidazole.

In one embodiment of the process of the invention, the amine catalyst is used in an amount of 10-50 000 ppm (based on the total mass of the product), preferably 100-10 000 ppm.

According to the standard technical definition, a solvent is understood to mean one or more compounds that dissolve the H-functional starter compound (1), the cyclic anhydride (2), the alkylene oxide (3) and/or the catalyst (4), but without itself reacting with the H-functional starter compound (1), the cyclic anhydride (2), the alkylene oxide (3) and/or the catalyst (4).

In one embodiment, the process of the invention is performed without addition of a solvent, such that there is no need to remove this solvent in an additional process step after the preparation of the etheresterol, preferably the polyetheresterol.

In one embodiment, the process of the invention comprises the following steps:
i) reacting the H-functional starter substance (1) of the cyclic anhydride (2) and the first portion (m3-1) of the alkylene oxide (3) to form a mixture (i)
ii) adding the portion (m4-2) of the catalyst (4) to the compound (i) to form a mixture (ii)
iii) reacting the mixture (ii) with the second portion (m3-2) of the alkylene oxide (3) to form the etheresterol, preferably a polyetheresterol.

In a preferred embodiment of the of the invention, a portion (m4-1) of the catalyst (4) is added in step i), which achieves a further reduction in the viscosity of the etheresterol, preferably of a polyetheresterol.

In an alternative embodiment, the process according to the invention comprises the following steps:
α) reacting the starter substance (1) and the cyclic anhydride (2) to form a mixture (α)
β) adding the first portion (m3-1) of the alkylene oxide (3) to component (α) to form a compound (β)
γ) adding the portion (m4-2) of the catalyst (4) to the compound (β) to form a mixture (γ)
δ) reacting the mixture (γ) with the second portion (m3-2) of the alkylene oxide (3) to form the etheresterol, preferably a polyetheresterol.

In a preferred embodiment of the of the invention, a portion (m4-1) of the catalyst (4) is added in step α), which achieves a further reduction in the viscosity of the etheresterol, preferably of a polyetheresterol.

In one embodiment of the process of the invention, for the aforementioned process alternatives, 50.1 mol % to 100 mol %, preferably 60 mol % to 100 mol %, of the portion (m4-2) of the catalyst, based on the sum total of the portion (m4-1) and portion (m4-2), is added.

The tertiary amine added in portion (m4-1) may be identical to or different than the tertiary amine added as portion (m4-2) here. The amines added are preferably identical.

In one embodiment of the process of the invention, the molar ratio of the cyclic anhydride (2) to the starter functionality of the H-functional starter substance (1) is between 0.5:1 and 20:1, preferably between 0.5:1 and 10:1.

In one embodiment of the process of the invention, the H-functional starter substance (1) is an OH-functional starter substance (1-1) having terminal hydroxyl groups, and the molar ratio of the alkylene oxide (3) to the cyclic anhydride (2) is from 1.05:1 to 3.0:1, preferably from 1.1:1 to 2.0:1.

In one embodiment of the process of the invention, the H-functional starter substance (1) is an OH-functional starter substance (1-1) having terminal hydroxyl groups, and the molar ratio of the alkylene oxide (3) to the cyclic anhydride (2) is from 1.05:1 to 3.0:1, preferably from 1.1:1 to 2.0:1.

In one embodiment of the process of the invention, the portion (m3-1) is 10 to 95 mol %, preferably 30 to 85 mol %, based on the sum total of the portions (m3-1) and (m3-2) of the alkylene oxide (3).

The alkylene oxide added in portion (m3-1) may be identical to or different than the alkylene oxide added as portion (m3-2) here. The alkylene oxides added are preferably identical.

In a further embodiment of the process of the invention, the H-functional starter substance (1) is added to the reactor continuously.

In a further embodiment of the process of the invention, the cyclic anhydride (2) is added to the reactor continuously or stepwise.

In a further embodiment of the process of the invention, the cyclic alkylene oxide (3) is added to the reactor continuously or stepwise.

In a further embodiment of the process of the invention, the catalyst (4) is added to the reactor continuously or stepwise.

In a further embodiment of the process of the invention, in step i), the reactor is initially charged with the H-functional starter substance (1), and the cyclic anhydride (2) is added to the reactor stepwise or continuously.

In a further alternative embodiment of the process of the invention, in step i), the reactor is initially charged with the cyclic anhydride (2), and the H-functional starter substance (1) is added to the reactor stepwise or continuously.

In a further alternative embodiment of the process of the invention, the polyester polyol is withdrawn from the reactor continuously or stepwise, preferably continuously.

The present invention further provides an etheresterol, preferably a polyetheresterol, obtainable by the stipulated process of the invention.

In one embodiment, the etheresterol of the invention, preferably a polyetheresterol, has a number-average molecular weight of 70 g/mol to 10 000 g/mol, preferably of 80 g/mol to 5000 g/mol, the number-average molecular weight being determined by means of gel permeation chromatography (GPC) as disclosed in the experimental section.

The present invention further provides a process for preparing a polyurethane by reaction of the etheresterol of the invention, preferably a polyetheresterol, with a polyisocyanate.

The polyisocyanate may be an aliphatic or aromatic polyisocyanate. Examples include butylene 1,4-diisocyanate, pentane 1,5-diisocyanate, hexamethylene 1,6-diisocyanate (HDI) or their dimers, trimers, pentamers, heptamers or nonamers or mixtures thereof, isophorone diisocyanate (IPDI), 2,2,4- and/or 2,4,4-trimethylhexamethylene diisocyanate, isomeric bis(4,4′-isocyanatocyclohexyl)methanes or mixtures thereof having any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), and alkyl 2,6-diisocyanatohexanoates (lysine diisocyanates) having C1 to C6 alkyl groups. Preference is given here to an isocyanate from the diphenylmethane diisocyanate series.

In addition to the abovementioned polyisocyanates, it is also possible to use proportions of modified diisocyanates having uretdione, isocyanurate, urethane, carbodiimide, uretonimine, allophanate, biuret, amide, iminooxadiazinedione and/or oxadiazinetrione structure, and also unmodified polyisocyanate having more than 2 NCO groups per molecule, for example 4-isocyanatomethyloctane 1,8-diisocyanate (nonane triisocyanate) or triphenylmethane 4,4′,4″-triisocyanate.

In a first embodiment, the invention relates to a process for preparing an etheresterol, preferably a polyetheresterol, by reacting an H-functional starter substance (1) with a cyclic anhydride (2) and an alkylene oxide (3) in the presence of a catalyst (4), wherein the alkylene oxide (3) in the total amount (m3) is added in at least two portions (m3-1) and (m3-2);

wherein the catalyst (4) in the total amount (m4) is added in at least one portion (m4-2);
wherein the portion (m4-2) of the catalyst (4) is added after the first portion (m3-1) of the alkylene oxide (4);
and wherein the addition of the total amount (m4) of the catalyst (4) is concluded before the addition of the total amount (m3) of the alkylene oxide (3);
and wherein the catalyst (4) is a tertiary amine.

In a second embodiment, the invention relates to a process according to the first embodiment, comprising the following steps:
i) reacting the H-functional starter substance (1) of the cyclic anhydride (2) and the first portion (m3-1) of the alkylene oxide (3) to form a mixture (i)
ii) adding the portion (m4-2) of the catalyst (4) to the compound (i) to form a mixture (ii)
iii) reacting the mixture (ii) with the second portion (m3-2) of the alkylene oxide (3) to form the etheresterol, preferably a polyetheresterol.

In a third embodiment, the invention relates to a process according to the second embodiment, wherein a portion (m4-1) of the catalyst (4) is added in step i).

In a fourth embodiment, the invention relates to a process according to the first embodiment, comprising
α) reacting the starter substance (1) and the cyclic anhydride (2) to form a mixture (α)
β) adding the first portion (m3-1) of the alkylene oxide (3) to component (α) to form a compound (β)
γ) adding the portion (m4-2) of the catalyst (4) to the compound (β) to form a mixture (γ)
δ) reacting the mixture (γ) with the second portion (m3-2) of the alkylene oxide (3) to form the etheresterol, preferably a polyetheresterol.

In a fifth embodiment, the invention relates to a process according to the fourth embodiment, wherein a portion (m4-1) of the catalyst (4) is added in step α).

In a sixth embodiment, the invention relates to a process according to any of the third to fifth embodiments, wherein 50.1 mol % to 100 mol %, preferably 60 mol % to 100 mol %, of the portion (m4-2) of the catalyst, based on the sum total of the portion (m4-1) and portion (m4-2), is added.

In a seventh embodiment, the invention relates to a process according to any of the first to sixth embodiments, wherein the H-functional starter substance (1) is an OH-functional starter substance (1-1), an NH2-functional starter substance (1-2), an NH-functional starter substance (1-3) and/or a COOH-functional starter substance (1-4), preferably an OH-functional starter substance (1-1).

In an eighth embodiment, the invention relates to a process according to any of the first to seventh embodiments, wherein the alkylene oxide (3) is propylene oxide and/or ethylene oxide, preferably ethylene oxide.

In a ninth embodiment, the invention relates to a process according to any of the first to eighth embodiments, wherein the tertiary amine is one or more compound(s) and is selected from the group consisting of trimethylamine, triethylenediamine, tripropylamine, tributylamine, tripentylamine, trihexylamine, triphenylamine, dimethylethylamine, N,N-dimethylcyclohexylamine, tetramethylenediamine, 1-methyl-4-dimethylaminoethylpiperazine, triethylamine, tripropylamine, tributylamine, dimethylbutylamine, N,N-dimethylbenzylamine, N,N-dimethylcyclohexylamine, N,N′,N″-tris(dimethylaminopropyl)hexahydrotriazine, dimethylaminopropylformamide, N,N,N′,N′-tetramethylethylenediamine, N,N,N′,N′-tetramethylbutanediamine, tetramethylhexanediamine, pentamethyldiethylenetriamine, tetramethyldiaminoethyl ether, dimethylpiperazine, 1,2-dimethylimidazole, 1-azabicyclo[3.3.0]octane, bis(dimethylaminopropyl)urea, bis(dimethylaminoethyl) ether, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, 1,8-diazabicyclo[5.4.0]undec-7-ene (DBU), 1,5,7-triazabicyclo[4.4.0]dec-5-ene (TBD), 1,4-diazabicyclo[2.2.2]octane (DABCO), imidazole, 1-methylimidazole, 2-methylimidazole, 4(5)-methylimidazole, 2,4(5)-dimethylimidazole, 1-ethylimidazole, 2-ethylimidazole, 1-phenylimidazole, 2-phenylimidazole, 4(5)-phenylimidazole and N,N-dimethylaminopyridine, guanidine, 1,1,3,3-tetramethylguanidine, pyridine, 1-azanaphthalene (quinoline), N-methylpiperidine, N-methylmorpholine, N,N′-dimethylpiperazine and N,N-dimethylaniline, preferably benzyldimethylamine, N,N-dimethylcyclohexylamine, diazabicyclo[2.2.2]octane (DABCO), imidazole, 1-methylimidazole, 2-methylimidazole, 4(5)-methylimidazole, 2,4(5)-dimethylimidazole, 1-ethylimidazole, 2-ethylimidazole, 1-phenylimidazole, 2-phenylimidazole, and 4(5)-phenylimidazole.

In a tenth embodiment, the invention relates to a process according to any of the first to ninth embodiments, wherein the molar ratio of the cyclic anhydride (2) to the starter functionality of the H-functional starter substance (1) is between 0.5:1 and 20:1, preferably between 0.5:1 and 10:1.

In an eleventh embodiment, the invention relates to a process according to any of the seventh to tenth embodiments, the H-functional starter substance (1) is an OH-functional starter substance (1-1) having terminal hydroxyl groups, and the molar ratio of the alkylene oxide (3) to the cyclic anhydride (2) is from 1.05:1 to 3.0:1, preferably from 1.1:1 to 2.0:1.

In a twelfth embodiment, the invention relates to a process according to any of the first to eleventh embodiments, wherein the H-functional starter substance (1) is a COOH-functional starter substance (1-4) having carboxyl groups, and the molar ratio of the alkylene oxide (3) to the cyclic anhydride (2) is from 1.5:1 to 8.0:1, preferably from 1.8:1 to 5.0:1.

In a thirteenth embodiment, the invention relates to a process according to any of the first to twelfth embodiments, wherein the portion (m3-1) is 10 to 95 mol %, preferably 30 to 85 mol %, based on the sum total of the portions (m3-1) and (m3-2) of the alkylene oxide (3).

In a fourteenth embodiment, the invention relates to a process according to any of the first to twelfth embodiments, wherein no solvent is used.

In a fifteenth embodiment, the invention relates to a process according to any of the first to fourteenth embodiments, wherein the H-functional starter substance (1) is one or more compound(s) and is selected from the group consisting of ethylene glycol, diethylene glycol, dipropylene glycol, butane-1,3-diol, butane-1,4-diol, 1,1,1-trimethylolpropane, glycerol, pentaerythritol, sorbitol, sucrose, xylitol, propane-1,2-diol, propane-1,3-diol, succinic acid, adipic acid, glutaric acid, pimelic acid, maleic acid, phthalic acid, terephthalic acid, lactic acid, citric acid and salicylic acid.

In a fifteenth embodiment, the invention relates to a process according to any of the first to fourteenth embodiments, wherein the cyclic anhydride (2) is one or more compound(s) and is selected from the group consisting of succinic anhydride, maleic anhydride, phthalic anhydride, cyclohexane-1,2-dicarboxylic anhydride, diphenic anhydride, tetrahydrophthalic anhydride, methyltetrahydrophthalic anhydride, norbornenedioic anhydride and the chlorination products thereof, succinic anhydride, glutaric anhydride, diglycolic anhydride, 1,8-naphthalic anhydride, succinic anhydride, dodecenylsuccinic anhydride, tetradecenylsuccinic anhydride, hexadecenylsuccinic anhydride, octadecenylsuccinic anhydride, 3- and 4-nitrophthalic anhydride, tetrachlorophthalic anhydride, tetrabromophthalic anhydride, itaconic anhydride, dimethylmaleic anhydride, allylnorbornenedioic anhydride, 3-methylfuran-2,5-dione, 3-methyldihydrofuran-2,5-dione, dihydro-2H-pyran-2,6(3H)-dione, 1,4-dioxane-2,6-dione, 2H-pyran-2,4,6(3H,5H)-trione, 3-ethyldihydrofuran-2,5-dione, 3-methoxydihydrofuran-2,5-dione, 3-(prop-2-en-1-yl)dihydrofuran-2,5-dione, N-(2,5-dioxotetrahydrofuran-3-yl)formamide and 3 [(2E)-but-2-en-1-yl]dihydrofuran-2,5-dione, preferably succinic anhydride, maleic anhydride and phthalic anhydride.

In a sixteenth embodiment, the invention relates to a process according to any of the first to fifteenth embodiments, wherein the H-functional starter substance (1) is added to the reactor continuously.

In a seventeenth embodiment, the invention relates to a process according to any of the first to sixteenth embodiments, wherein the cyclic anhydride (2) is added to the reactor continuously or stepwise.

In an eighteenth embodiment, the invention relates to a process according to any of the first to seventeenth embodiments, wherein the cyclic alkylene oxide (3) is added to the reactor continuously or stepwise.

In a nineteenth embodiment, the invention relates to a process according to any of the first to seventeenth embodiments, wherein the tertiary amine as catalyst (4) is added to the reactor continuously or stepwise.

In a twentieth embodiment, the invention relates to a process according to any of the first to third and sixth to nineteenth embodiments, wherein, in step i), the reactor is initially charged with the H-functional starter substance (1) and the cyclic anhydride (2) is added to the reactor stepwise or continuously.

In a twenty-first embodiment, the invention relates to a process according to any of the first to third and sixth to twentieth embodiments, wherein, in step i), the reactor is initially charged with the cyclic anhydride (2) and the H-functional starter substance (1) is added to the reactor stepwise or continuously.

In a twenty-second embodiment, the invention relates to a process according to any of the first to third and sixth to twenty-first embodiments, wherein, in step i), the first portion (m3-1) of the alkylene oxide (3) is added continuously.

In a twenty-third embodiment, the invention relates to a process according to any of the first to third and sixth to twenty-second embodiments, wherein, in step iii), the second portion (m3-2) of the alkylene oxide (3) is added continuously.

In a twenty-fourth embodiment, the invention relates to a process according to any of the first and fourth to twenty-first embodiments, wherein, in step β), the first portion (m3-1) of the alkylene oxide (3) is added continuously.

In a twenty-fifth embodiment, the invention relates to a process according to any of the first and fourth to twenty-first and twenty-fourth embodiments, wherein, in step β), the second portion (m3-2) of the alkylene oxide (3) is added continuously.

In a twenty-sixth embodiment, the invention relates to a process according to any of the first to twenty-fifth embodiments, wherein the polyester polyol is withdrawn from the reactor continuously.

In a twenty-seventh embodiment, the invention relates to an etheresterol, preferably polyetheresterol, obtainable according to at least one of the first to twenty-sixth embodiments.

In a twenty-eighth embodiment, the invention relates to a process for preparing a polyurethane by reaction of the etheresterol, preferably the polyetheresterol, according to the twenty-seventh embodiment with a polyisocyanate.

In a twenty-ninth embodiment, the invention relates to a process according to the twenty-eighth embodiment, wherein the polyisocyanate is one or more compound(s) and is selected from the group consisting of butylene 1,4-diisocyanate, pentane 1,5-diisocyanate, hexamethylene 1,6-diisocyanate (HDI) or their dimers, trimers, pentamers, heptamers or nonamers or mixtures thereof, isophorone diisocyanate (IPDI), 2,2,4- and/or 2,4,4-trimethylhexamethylene diisocyanate, isomeric bis(4,4′-isocyanatocyclohexyl)methanes or mixtures thereof having any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), alkyl 2,6-diisocyanatohexanoates (lysine diisocyanates) having C1 to C6 alkyl groups.

### EXAMPLES

The present invention is more particularly elucidated with reference to the figures and examples which follow but without being limited thereto.

Starting Materials Used

H-Functional Starter Substance (1): “Starter (1)”

| | |
|---|---|
| diethylene glycol (DEG) | (purity 99%, Sigma-Aldrich) |
| PEG-200 (PEG) | (Sigma-Aldrich) |
| adipic acid (AA) | (purity 99.5% (BioXtra), Sigma Aldrich) |
| octane-1,8-diol (OD) | (purity 98%, Sigma Aldrich GmbH) |

Cyclic Anhydride (2): “CA (2)”

| | |
|---|---|
| succinic anhydride (SA) | (purity 99%, ABCR) |
| phthalic anhydride (PA) | (purity ≥99%, Sigma Aldrich) |

Alkylene Oxide (3): “AO (3)”

| | |
|---|---|
| ethylene oxide | EO (3.0 Gerling Holz) |

Catalysts: “Cat (4)”

| | |
|---|---|
| benzyldimethylamine (BDA) | (purity ≥99%, Sigma Aldrich) |
| trifluoromethanesulfonic acid (TfOH) | (purity 98%, Sigma-Aldrich) |

DMC catalyst (DMC): All examples employed a DMC catalyst
produced according to example 6 in WO 01/80994 A1.

Description of the Methods:

OH number: The OH number was determined by the method of DIN 53240-1.

COOH number: The acid number was determined according to DIN EN ISO 2114.

Viscosity: MCR 51 rheometer from Anton Paar in accordance with DIN 53019-1 using a CP 50-1 measuring cone, diameter 50 mm, angle 1° at shear rates of 25, 100, 200 and 500 s⁻¹. The inventive and noninventive polyols show viscosity values that are independent of the shear rate.

Gel permeation chromatography (GPC): Measurements were performed on an Agilent 1200 Series (G1311A Bin Pump, G1313A ALS, G1362A RID), detection by RID; eluent: tetrahydrofuran (GPC grade), flow rate 1.0 ml/min at 40° C. column temperature; column combination: 2×PSS SDV precolumn 100 Å (5 μm), 2×PSS SDV 1000 Å (5 μm). Calibration was effected using ReadyCal Kit Poly(styrene) low in the range of Mp=266-66 000 Da from “PSS Polymer Standards Service”. The measurement recording and evaluation software used was the “PSS WinGPC Unity” software package. The polydispersity index from weighted (Mw) and number-average (Mn) molecular weight from the gel permeation chromatography is defined as Mw/Mn.

### Example 1: EO/SA-Based Polyetherester Polyol

A 2.0 L steel reactor is initially charged with diethylene glycol (110 g, 1.04 mol, 1.00 eq.), succinic anhydride (311 g, 3.11 mol, 3.00 eq.) and the first portion of catalyst (benzyldimethylamine, 97 mg, 150 ppm). The reactor is sealed tight and inertized with N₂ (3×25 bar N₂→1-2 bar N₂). The reactor is heated to 125° C. under N₂ atmosphere in order to melt the succinic anhydride. It is subsequently stirred at 1200 rpm at 125° C. for 60 min. The N₂ pressure is adjusted to 45 bar, and ethylene oxide (114 g, 2.59 mol, 2.50 eq.) is metered in at 125° C. for 45 min. The metered addition is then stopped and the mixture is stirred at 125° C. for 30 min. The second portion of the catalyst is added (benzyldimethylamine, 552 mg, 850 ppm). Subsequently, ethylene oxide is metered in for a further 45 min (114 g, 2.59 mol, 2.50 eq.). The reaction is stirred at 125° C. for a further 120 min. The reactor is cooled down, vented and purged with N₂. Volatile components are removed under reduced pressure.

### Example 2: EO/SA-Based Polyetherester Polyol

Procedure analogous to example 1. The first portion of catalyst (benzyldimethylamine) is 650 mg (1000 ppm), and the second portion 0 mg (0 ppm).

### Example 3: EO/SA-Based Polyetherester Polyol

Procedure analogous to example 1. The first portion of catalyst (benzyldimethylamine) is 0 mg (0 ppm), and the second portion 975 mg (1500 ppm).

### Example 4: EO/SA-Based Polyetherester Polyol

Procedure analogous to example 1. The first portion of catalyst (benzyldimethylamine) is 195 mg (300 ppm), and the second portion 779 mg (1200 ppm).

### Example 5: EO/SA-Based Polyetherester Polyol

A 2.0 L steel reactor is initially charged with a mixture of diethylene glycol (100 g, 0.94 mol, 0.79 eq.), PEG-200 (50 g, 0.25 mol, 0.21 eq.), succinic anhydride (328 g, 3.27 mol, 3.00 eq.) and the first portion of catalyst (benzyldimethylamine, 0 mg, 0 ppm). The reactor is sealed tight and inertized with N₂ (3×25 bar N₂→1-2 bar N₂). The reactor is heated to 125° C. under N₂ atmosphere in order to melt the succinic anhydride. It is subsequently stirred at 1200 rpm at 125° C. for 60 min. The N₂ pressure is adjusted to 45 bar, and ethylene oxide (95.5 g, 2.17 mol, 1.99 eq.) is metered in at 125° C. for 45 min. The metered addition is then stopped and the mixture is stirred at 125° C. for 30 min. The second portion of the catalyst is added (benzyldimethylamine, 1.00 g, 1500 ppm). Subsequently, ethylene oxide is metered in for a further 45 min (95.5 g, 2.17 mol, 1.99 eq.). The reaction is stirred at 125° C. for a further 120 min. The reactor is cooled down, vented and purged with N₂. Volatile components are removed under reduced pressure.

### Comparative Example 6: EO/SA-Based Polyetherester Polyol

A 2.0 L steel reactor is initially charged with a mixture of diethylene glycol (100 g, 0.94 mol, 0.79 eq.), PEG-200 (50 g, 0.25 mol, 0.21 eq.), succinic anhydride (328 g, 3.27 mol, 3.00 eq.) and the first portion of catalyst (benzyldimethylamine, 1.00 g, 1500 ppm). The reactor is sealed tight and inertized with N₂ (3×25 bar N₂→1-2 bar N₂). The reactor is heated to 125° C. under N₂ atmosphere in order to melt the succinic anhydride. It is subsequently stirred at 1200 rpm at 125° C. for 60 min. The N₂ pressure is adjusted to 45 bar, and ethylene oxide (191 g, 4.34 mol, 3.98 eq.) is metered in at 125° C. for 90 min. The reaction is stirred at 125° C. for a further 150 min. The reactor is cooled down, vented and purged with N₂. Volatile components are removed under reduced pressure.

### Example 7: EO/PA-Based Polyetherester Polyol

A 2.0 L steel reactor is initially charged with a mixture of diethylene glycol (94.1 g, 0.887 mol, 0.68 eq.), adipic acid (75.0 g, 0.425 mol, 0.32 eq.), phthalic anhydride (270 g, 1.82 mol, 1.39 eq.) and the first portion of catalyst (benzyldimethylamine, 0 mg, 0 ppm). The reactor is sealed tight and inertized with N₂ (3×25 bar N₂→1-2 bar N₂). The reactor is heated to 135° C. under N₂ atmosphere in order to melt the phthalic anhydride. It is subsequently stirred at 1200 rpm at 135° C. for 60 min. The N₂ pressure is adjusted to 45 bar, and ethylene oxide (128 g, 2.91 mol, 2.21 eq.) is metered in at 135° C. for 45 min. After the metered addition has commenced, the temperature is reduced to 130° C. within 5-10 min. The metered addition is then stopped and the mixture is stirred at 130° C. for 30 min. The second portion of the catalyst is added (benzyldimethylamine, 1.04 g, 1500 ppm). Subsequently, ethylene oxide is metered in at 130° C. for a further 45 min (128 g, 2.91 mol, 2.21 eq.). The reaction is stirred at 130° C. for a further 120 min. The reactor is cooled down, vented and purged with N₂. Volatile components are removed under reduced pressure.

### Example 8: EO/PA-Based Polyetherester Polyol

Procedure analogous to example 7. The first portion of catalyst (benzyldimethylamine) is 104 mg (150 ppm), and the second portion 938 mg (1350 ppm).

### Example 9: EO/PA-Based Polyetherester Polyol

Procedure analogous to example 7. The first portion of catalyst (benzyldimethylamine) is 208 mg (300 ppm), and the second portion 833 mg (1200 ppm).

### Comparative Example 10: EO/SA-Based Polyetherester Polyol

A 300 mL steel reactor is initially charged with diethylene glycol (16.7 g, 0.16 mol, 1.00 eq.), succinic anhydride (47.2 g, 0.47 mol, 3.00 eq.) and the first portion of catalyst (trifluoromethanesulfonic acid, 148 mg, 1500 ppm). The reactor is sealed tight and inertized with N₂ (3×25 bar N₂→1-2 bar N₂). The reactor is heated to 125° C. under N₂ atmosphere in order to melt the succinic anhydride. It is subsequently stirred at 1200 rpm at 125° C. for 60 min. The N₂ pressure is adjusted to 45 bar, and ethylene oxide (34.7 g, 2.59 mol, 5.00 eq.) is metered in at 125° C. for 90 min. The reaction is stirred at 125° C. for a further 150 min. The reactor is cooled down, vented and purged with N₂. Volatile components are removed under reduced pressure.

### Comparative Example 11: EO/PA-Based Polyetherester Polyol

A 300 mL steel reactor is initially charged with a mixture of diethylene glycol (12.6 g, 0.118 mol, 0.68 eq.), adipic acid (10.0 g, 0.060 mol, 0.32 eq.), phthalic anhydride (36.0 g, 0.243 mol, 1.39 eq.) and catalyst (trifluoromethanesulfonic acid, 0.140 mg, 1500 ppm). The reactor is sealed tight and inertized with N₂ (3×25 bar N₂→1-2 bar N₂). The reactor is heated to 135° C. under N₂ atmosphere in order to melt the phthalic anhydride. It is subsequently stirred at 1200 rpm at 135° C. for 60 min. The N₂ pressure is adjusted to 45 bar, and ethylene oxide (34.1 g, 0.77 mol, 2.21 eq.) is metered in at 135° C. for 90 min. After the metered addition has commenced, the temperature is reduced to 130° C. within 5-10 min. The reaction is stirred at 130° C. for a further 150 min. The reactor is cooled down, vented and purged with N₂. Volatile components are removed under reduced pressure.

### Comparative Example 12: EO/SA-Based Polyetherester Polyol

A 300 mL steel reactor is initially charged with diethylene glycol (16.7 g, 0.16 mol, 1.00 eq.), succinic anhydride (47.2 g, 0.47 mol, 3.00 eq.) and the first portion of catalyst (DMC, 148 mg, 1500 ppm). The reactor is sealed tight and inertized with N₂ (3×25 bar N₂→1-2 bar N₂). The reactor is heated to 125° C. under N₂ atmosphere in order to melt the succinic anhydride. It is subsequently stirred at 1200 rpm at 125° C. for 60 min. The N₂ pressure is adjusted to 45 bar, and ethylene oxide (34.7 g, 2.59 mol, 5.00 eq.) is metered in at 125° C. for 90 min. The reaction is stirred at 125° C. for a further 150 min. The reactor is cooled down, vented and purged with N₂. Volatile components are removed under reduced pressure. It is found that no reaction has taken place.

In a further experiment, the DMC catalyst was first added to the reaction mixture directly before the addition of EO; here too, the conversion of E0 and succinic anhydride was incomplete.

TABLE 1
Comparison of experiments 1 to 12.

| | | CA (2) | AO (3) | Cat | m(3-1) | m(3-2) | m(4-l) | m(4-2) |
|---|---|---|---|---|---|---|---|---|
| Ex. | [eq] | [eq] | [eq] | (4) | [mol %] | [mol %] | [mol %] | [mol %] |
| 1 | DEG (1.00) | SA (3.11) | EO (5.00) | BDA | 50 | 50 | 15 | 85 |
| 2 | DEG (1.00) | SA (3.11) | EO (5.00) | BDA | 50 | 50 | 100 | 0 |
| (comp.) | | | | | | | | |
| 3 | DEG (1.00) | SA (3.11) | EO (5.00) | BDA | 50 | 50 | 0 | 100 |
| 4 | DEG (1.00) | SA (3.11) | EO (5.00) | BDA | 50 | 50 | 20 | 80 |
| 5 | DEG: 67 wt % | SA (3.00) | EO (4.00) | BDA | 50 | 50 | 0 | 100 |
| | PEG: 33 wt % Σ (1.00 eq) | | | | | | | |
| 6 | DEG: 67 wt % | SA (3.00) | EO (4.00) | BDA | 50 | 50 | 100 | 0 |
| (comp.) | PEG: 33 wt % Σ (1.00 eq) | | | | | | | |
| 7 | DEG: 44 wt % | PA (1.36) | EO (4.34) | BDA | 33 | 67 | 0 | 100 |
| | AA: 56 wt % Σ (1.00 eq) | | | | | | | |
| 8 | DEG: 44 wt % | PA (1.36) | EO (4.34) | BDA | 33 | 67 | 10 | 90 |
| | AA: 56 wt % Σ (1.00 eq) | | | | | | | |
| 9 | DEG: 44 wt % | PA (1.36) | EO (4.34) | BDA | 33 | 67 | 20 | 80 |
| | AA: 56 wt % Σ (1.00 eq) | | | | | | | |
| 10 | DEG (1.00) | SA (3.11) | EO (5.00) | TfOH | 0 | 100 | 100 | 0 |
| (comp.) | | | | | | | | |
| 11 | DEG: 44 wt % | PA (1.36) | EO (4.34) | TfOH | 0 | 100 | 100 | 0 |
| (comp.) | AA: 56 wt % Σ (1.00 eq) | | | | | | | |
| 12 | OD(1.00 eq) | SA (3.11) | EO (5.00) | DMC | 0 | 100 | 100 | 0 |
| (comp.) | | | | | | | | |

| | | X(EO)^{[a]} | OH^{#[b]} | COOH^{#} | Visc.^{[c]} | Mn ^{[d]} | |
|---|---|---|---|---|---|---|---|
| Ex. | [eq] | [%] | [mg/g] | [mg/g] | [mPas] | [g/mol] | D^{[d]} |
| 1 | DEG (1.00) | 87 | 208 | 1.9 | 2990 | 870 | 1.59 |
| 2 | DEG (1.00) | 70 | 206 | 0.1 | 4250 | 870 | 1.58 |
| (comp.) | | | | | | | |
| 3 | DEG (1.00) | 79 | 215 | 1.1 | 3280 | 800 | 1.59 |
| 4 | DEG (1.00) | 77 | 206 | 1.7 | 3900 | 830 | 1.60 |
| 5 | DEG: 67 wt % | 95 | 212 | 0.4 | 1680 | 870 | 1.48 |
| | PEG: 33 wt % Σ (1.00 eq) | | | | | | |
| 6 | DEG: 67 wt % | 86 | 234 | 0.2 | solid | 820 | 1.52 |
| (comp.) | PEG: 33 wt % Σ (1.00 eq) | | | | (Tₘ: | | |
| 7 | DEG: 44 wt % | 90 | 251 | 0.7 | 4870 | 670 | 1.42 |
| | AA: 56 wt % Σ (1.00 eq) | | | | | | |
| 8 | DEG: 44 wt % | 86 | 258 | 0.5 | 6060 | 660 | 1.45 |
| | AA: 56 wt % Σ (1.00 eq) | | | | | | |
| 9 | DEG: 44 wt % | 80 | 254 | 1.6 | 6130 | 640 | 1.44 |
| | AA: 56 wt % Σ (1.00 eq) | | | | | | |
| 10 | DEG (1.00) | n.d. | n.d. | 44 | 5170 | 770 | 1.94 |
| (comp.) | | | | | | | |
| 11 | DEG: 44 wt % | n.d. | n.d. | 47 | 7940 | 560 | 1.83 |
| (comp.) | AA: 56 wt % Σ (1.00 eq) | | | | | | |
| 12 | OD(1.00 eq) | —^{[e]} | —^{[e]} | —^{[e]} | —^{[e]} | —^{[e]} | —^{[e]} |
| (comp.) | | | | | | | |

^{[a]}ethylene oxide conversion X(EO)
^{[b]}sum total of measured OH# to DIN 53240-1 and of the ascertained COOH# to DIN EN ISO 2114;
^{[c]}viscosity ascertained via MCR 51 rheometer from Anton Paar in accordance with DIN 53019-1 at 25° C.;
^{[d]}ascertained via GPC analysis in THF,
^{[e]}incomplete conversion of the reactants;
n.d. - not determined

1. A process for preparing an etheresterol, the process comprising reacting an H-functional starter substance with a cyclic anhydride and an alkylene oxide in the presence of a catalyst, wherein a total amount of the alkylene oxide is added in at least two portions, including a first oxide portion and a second oxide portion;
wherein a total amount of the catalyst is added in at least one portion including a first catalyst portion;
wherein the first catalyst portion of the total amount of catalyst is added after adding the first oxide portion of the total amount of alkylene oxide;
wherein the addition of the total amount of the catalyst is concluded before the addition of the total amount of the alkylene oxide; and
wherein the catalyst is a tertiary amine.

2. The process as claimed in claim 1, comprising the following steps:
i) reacting the H-functional starter substance of the cyclic anhydride and the first oxide portion of the total amount of alkylene oxide to form a first mixture;
ii) adding the first catalyst portion of the total amount of catalyst to the first mixture to form a second mixture; and
iii) reacting the second mixture with the second oxide portion of the total amount of alkylene oxide to form the etheresterol.

3. The process as claimed in claim 2, wherein a second catalyst portion of the total amount of catalyst is added in step i).

4. The process as claimed in claim 1, comprising
α) reacting the H-functional starter substance and the cyclic anhydride to form a first mixture;
β) adding the first oxide portion of the total amount of alkylene oxide to the first mixture to form a compound (β);
γ) adding the first catalyst portion of the total amount of catalyst to the compound (β) to form a second mixture; and
δ) reacting the second mixture with the second oxide portion of the total amount of alkylene oxide to form the etheresterol.

5. The process as claimed in claim 4, wherein a second catalyst portion of the total amount of catalyst is added in step α).

6. The process as claimed in claim 3, wherein 50.1 mol % to 100 mol % of the first catalyst portion of the catalyst, based on the sum total of the first catalyst portion and the second catalyst portion of the total amount of catalyst, is added.

7. The process as claimed in claim 1, wherein the H-functional starter substance is an OH-functional starter substance, an NH2-functional starter substance, an NH-functional starter substance and/or a COOH-functional starter substance.

8. The process as claimed in claim 1, wherein the alkylene oxide is propylene oxide and/or ethylene oxide.

9. The process as claimed in claim 1, wherein the tertiary amine is one or more compounds selected from the group consisting of trimethylamine, triethylenediamine, tripropylamine, tributylamine, tripentylamine, trihexylamine, triphenylamine, dimethylethylamine, N,N-dimethylcyclohexylamine, tetramethylenediamine, 1-methyl-4-dimethylaminoethylpiperazine, triethylamine, tripropylamine, tributylamine, dimethylbutylamine, N,N-dimethylbenzylamine, N,N-dimethylcyclohexylamine, N,N″,N″-tris(dimethylaminopropyl)hexahydrotriazine, dimethylaminopropylformamide, N,N,N″,N″-tetramethylethylenediamine, N,N,N″,N″-tetramethylbutanediamine, tetramethylhexanediamine, pentamethyldiethylenetriamine, tetramethyldiaminoethyl ether, dimethylpiperazine, 1,2-dimethylimidazole, 1-azabicyclo[3.3.0]octane, bis(dimethylaminopropyl)urea, bis(dimethylaminoethyl) ether, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, 1,8-diazabicyclo[5.4.0]undec-7-ene, 1,5,7-triazabicyclo[4.4.0]dec-5-ene, 1,4-diazabicyclo[2.2.2]octane, imidazole, 1-methylimidazole, 2-methylimidazole, 4(5)-methylimidazole, 2,4(5)-dimethylimidazole, 1-ethylimidazole, 2-ethylimidazole, 1-phenylimidazole, 2-phenylimidazole, 4(5)-phenylimidazole and N,N-dimethylaminopyridine, guanidine, 1,1,3,3-tetramethylguanidine, pyridine, 1-azanaphthalene (quinoline), N-methylpiperidine, N-methylmorpholine, N,N′-dimethylpiperazine and N,N-dimethylaniline.

10. The process as claimed in claim 1, wherein the molar ratio of the cyclic anhydride to the starter functionality of the H-functional starter substance is between 0.5:1 and 20:1.

11. The process as claimed in claim 7, wherein the H-functional starter substance is an OH-functional starter substance having terminal hydroxyl groups, and the molar ratio of the alkylene oxide to the cyclic anhydride is from 1.05:1 to 3.0:1.

12. The process as claimed in claim 1, wherein the H-functional starter substance is a COOH-functional starter substance having carboxyl groups, and the molar ratio of the alkylene oxide to the cyclic anhydride is from 1.5:1 to 8.0:1.

13. The process as claimed in claim 1, wherein the first oxide portion of the total amount of alkylene oxide is 10 to 95 mol % based on the sum total of the first and second oxide portions of the alkylene oxide.

14. An etheresterol obtainable by the process according to claim 1.

15. A process for preparing a polyurethane by reacting the etheresterol as claimed in claim 14 with a polyisocyanate.

16. The process as claimed in claim 1, wherein the etheresterol is a polyetheresterol.

17. The process as claimed in claim 7, wherein the H-functional starter substance is an OH-functional starter substance.

18. The process as claimed in claim 8, wherein the alkylene oxide is ethylene oxide.

19. The process as claimed in claim 9, wherein the tertiary amine is one or more compounds selected from the group consisting of benzyldimethylamine, N,N-dimethylcyclohexylamine, diazabicyclo[2.2.2]octane (DABCO), imidazole, 1-methylimidazole, 2-methylimidazole, 4(5-methylimidazole, 2,4(5)-dimethylimidazole, 1-ethylimidazole, 2-ethylimidazole, 1-phenylimidazole, 2-phenylimidazole, and 4(5)-phenylimidazole.

20. The process as claimed in claim 10, wherein the molar ratio of the cyclic anhydride to the starter functionality of the H-functional starter substance is between 0.5:1 and 10:1.
